(19) United States
(12) Patent Application Publication
(10) Pub. No.: US 2012/0314050 A1
(43) Pub. Date: Dec. 13, 2012

(54) IMAGING APPARATUS AND CONTROL METHOD THEREFOR

(75) Inventors: Ryo Nawata, Utsunomiya-shi (JP); Michio Yanagisawa, Utsunomiya-shi (JP); Yukio Tokuda, Kawasaki-shi (JP)

(73) Assignee: CANON KABUSHIKI KAISHA, Tokyo (JP)

(21) Appl. No.: 13/476,215

(22) Filed: May 21, 2012

(30) Foreign Application Priority Data
Jun. 13, 2011 (JP) 2011-131594

(51) Int. Cl. H04N 7/18

(52) U.S. Cl. 348/79; 348/E07.085

(57) ABSTRACT

An imaging apparatus comprises: a holding unit that holds a subject; a surface profile measuring unit that measures a surface profile of the subject; an imaging unit that adjusts an imaging plane according to the surface profile measured by the surface profile measuring unit and performs imaging of the subject; and a specifying unit that specifies a presence region in which an imaging object is present from an entire region of the subject. The surface profile measuring unit measures only the surface profile of the presence region specified by the specifying unit.

### BACKGROUND OF THE INVENTION

1. Field of the Invention

The present invention relates to an imaging apparatus and a control method therefore.

2. Description of the Related Art

Imaging systems constituted by an imaging apparatus that acquires a digital image (virtual slide image) by picking up an image of a slide and an image processing device that processes and analyzes the digital image and displays the result on a display unit have attracted attention in the field of pathology or the like.

Such a system is required to have a high resolution and perform high-speed imaging. Accordingly, in order to acquire efficiently high-resolution digital images, an imaging apparatus has been suggested in which a region where a specimen (analyte, biological sample) is present on a slide is measured in advance by macro-imaging the slide and high-resolution imaging is performed only in this region (Japanese Patent Application Laid-open No. 2007-310231). An imaging apparatus has also been suggested that has a preview camera and a high-magnification imaging unit and includes a routine of retrieving an image in which a specimen is present from preview images (Japanese Translation of PCT Application No. 2009-528580).

However, in the abovementioned high-magnification imaging apparatus, the depth of field of the imaging optical system (objective lens) is very small. Meanwhile, where a slide glass and a cover glass are adhesively bonded to seal a specimen between the slide glass and the cover glass, the cover glass and the specimen can be deformed and waviness sometimes appear on the specimen surface. Where such waviness appears on the specimen surface, part of the specimen does not fit into the depth of field and a good image with small blurring cannot be obtained. Therefore, it is desirable that the surface profile (waviness) of the cover glass surface be measured before the high-magnification imaging and the position and posture of the image sensor be adjusted according to the surface profile.

In this case, where the surface profile of the entire cover glass is wished to be measured at once, a surface profile measuring device increases in size. Thus, the measurement region of surface profile should be narrowed in order to prevent the increase in size of the surface profile measuring device. In this case, the processing speed (throughput) of the imaging apparatus decreases, unless the surface profile of the cover glass in the region where the specimen is present is measured with good efficiency.

### SUMMARY OF THE INVENTION

The present invention has been created with the foregoing in view and it is an object thereof to provide a technique for efficiently measuring the surface profile and increasing the throughput of the imaging apparatus.

The present invention in its first aspect provides an imaging apparatus including: a holding unit that holds a subject; a surface profile measuring unit that measures a surface profile of the subject; and an imaging unit that adjusts an imaging plane according to the surface profile measured by the surface profile measuring unit and performs imaging of the subject, wherein the imaging apparatus has a specifying unit that specifies a presence region in which an imaging object is present from an entire region of the subject; and the surface profile measuring unit measures only the surface profile of the presence region specified by the specifying unit.

The present invention in its second aspect provides a control method for an imaging apparatus provided with a holding unit that holds a subject; a surface profile measuring unit that measures a surface profile of the subject; and an imaging unit that adjusts an imaging plane according to the surface profile measured by the surface profile measuring unit and performs imaging of the subject, the control method including: a specifying step of specifying a presence region in which an imaging object is present from an entire region of the subject; and a measuring step of measuring by the surface profile measuring unit only a surface profile of the presence region specified in the specifying step.

In accordance with the present invention, the surface profile can be efficiently measured and the throughput of the imaging apparatus can be increased.

Further features of the present invention will become apparent from the following description of exemplary embodiments with reference to the attached drawings.

### BRIEF DESCRIPTION OF THE DRAWINGS

FIG. 1 illustrates an imaging apparatus of Embodiment 1;

FIGS. 2A and 2B illustrate a test object (slide) 30;

FIG. 3 shows an imaging optical system 40;

FIGS. 4A and 4B show an imaging unit 50;

FIG. 5 shows a surface profile measurement device 2;

FIG. 6 illustrates a presence region E of a specimen 302 of the test object 30;

FIG. 7 is an operation flowchart of Embodiment 1;

FIG. 8A is a time chart of Embodiment 1, and FIG. 8B is a time chart of a comparative example;

FIG. 9 illustrates an imaging apparatus of Embodiment 2;

FIG. 10 is an operation flowchart of Embodiment 2;

FIG. 11 is a time chart of Embodiment 2; and

FIG. 12 illustrates a transport method performed with a rotating table.

### DESCRIPTION OF THE EMBODIMENTS

### Embodiment 1

### (Configuration of Imaging Apparatus)

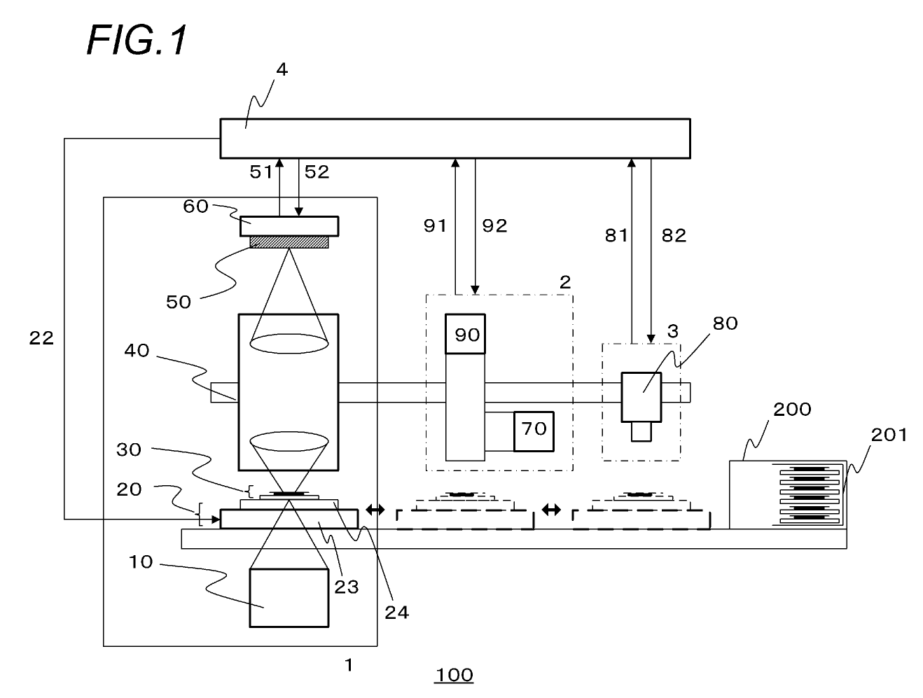

FIG. 1 illustrates an imaging apparatus 100 according to Embodiment 1 of the present invention. The configuration of the imaging apparatus 100 is explained with reference to FIG. 1. The imaging apparatus 100 is an apparatus for forming an optical image of the test object 30, which is a subject, at a high magnification and acquiring a highly detailed digital image. The digital image acquired by the imaging apparatus 100 is transmitted to an image processing device (computer) which is not shown in the figure, or displayed on a display device, or stored in a storage device. An imaging system can be constituted by the abovementioned imaging apparatus and image processing device (and also the display device or storage device). The configuration of the imaging apparatus is not limited to the example presented herein. For example, some or all of the functions of the image processing device, storage device, and display device may be carried out by the imaging apparatus.

The imaging apparatus 100 is constituted by a microscope 1, a surface profile measurement device 2, a wide-range image pickup device 3, a carry-in/carry-out device 200, and a control unit 4.

First, the microscope 1 will be described.

The microscope 1 has an illumination unit 10 that illuminates the test object (slide) 30, which is the subject, an imaging optical system 40 that forms an image of the test object 30, and an imaging unit 50 that performs imaging of the test object 30. The imaging unit 50 is constituted by a plurality of image sensors and an imaging stage 60 that holds the image sensors. A test object stage 20 is a holding unit for holding and moving the test object 30.

The test object stage 20 includes a holding member (not shown in the figure) that holds the test object 30, an XY stage 23 that moves the holding member in the X direction and Y direction, and a Z stage 24 that moves the holding member in the Z direction. In this case, the Z direction corresponds to the optical axis direction of the imaging optical system 40, and the X direction and Y direction correspond to directions perpendicular to the optical axis. For example, a plate spring, a vacuum suction unit, and an electrostatic absorption unit can be considered as the holding member. When a plate spring is used for the holding member, a method can be considered in which the non-imaging region of the test object 30 is pressed from the Z direction, or the side surface of the test object 30 is pressed from the X direction and Y direction. When a vacuum suction unit or an electrostatic absorption unit is used as the holding member, a method can be considered in which the non-imaging region of the test object 30 is attached from the rear surface of the test object 30. Apertures for allowing the light from the illumination unit 10 to pass therethrough are provided at the XY stage 23 and the Z stage 24.

The test object stage 20 of Embodiment 1 is configured to be reciprocatingly movable between the wide-range image pickup device 3, surface profile measurement device 2, and microscope 1, while holding the test object 30. As a result, in the test object stage 20 of Embodiment 1, the holding state of the test object 30 can be maintained. Therefore, Embodiment 1 is suitable in the case where highly accurate holding reproducibility is required for the wide-range image pickup device 3, surface profile measurement device 2, and microscope 1.

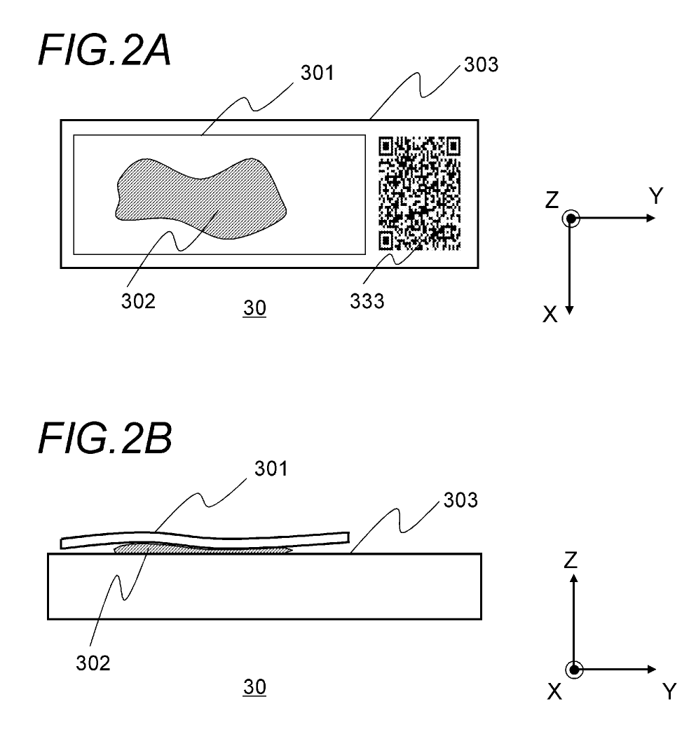

FIG. 2A is a view of the test object 30 taken from the Z direction, and FIG. 2B is a view of the test object 30 taken from the X direction. As shown in FIGS. 2A and 2B, a slide, which is an example of the test object 30, includes a cover glass 301, a specimen 302, and a slide glass 303. The specimen 302 (biological sample such as a tissue slice) placed on the slide glass 303 is sealed by the cover glass 301 and an adhesive (not shown in the figure). A label 333 having recorded thereon the information necessary for managing the test object 30 (specimen 302), such as the identification number of the slide glass and the thickness of the cover glass may be attached to the slide glass 303. Examples of suitable label 333 include a one-dimensional barcode, a two-dimensional barcode (matrix code, stack code) and a hand-written memo. In the present embodiment, a slide is described by way of example as the test object 30 serving as the object of image acquisition, but other objects may be also used as the test object.

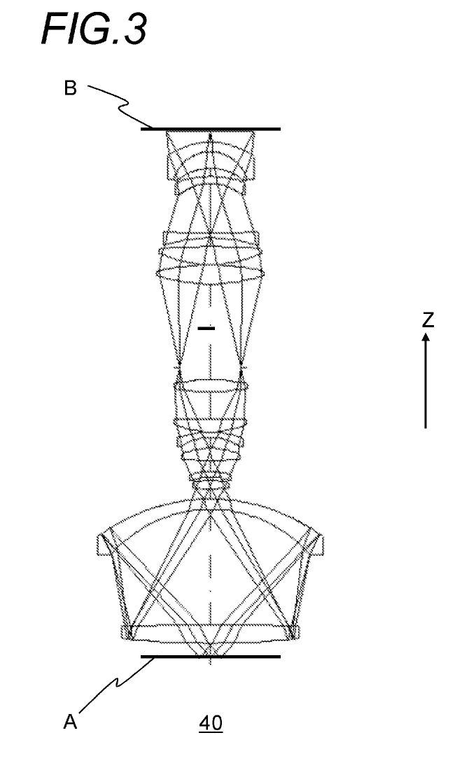

FIG. 3 is a schematic diagram illustrating the lens configuration of the imaging optical system 40. The imaging optical system 40 is an optical system for forming an image on the imaging plane of the imaging unit 50, while enlarging the image of the test object 30 at a predetermined magnification ratio. More specifically, as shown in FIG. 3, the imaging optical system 40 has a plurality of lenses and mirrors and forms on an image plane B an image of the object located on the object plane A. In the present embodiment, the imaging optical system 40 is arranged such that the test object 30 and the imaging plane of the imaging unit 50 are optically conjugated. The object plane A corresponds to the focusing plane on the test object 30, and the image plane B corresponds to the imaging plane of the imaging unit 50. The optical arrangement diagram in FIG. 3 illustrates an example in which the imaging optical system with the angle of view of 10 mm×10 mm and a numerical aperture NA on the object plane side of equal to or greater than 0.7 is configured using lenses and mirrors.

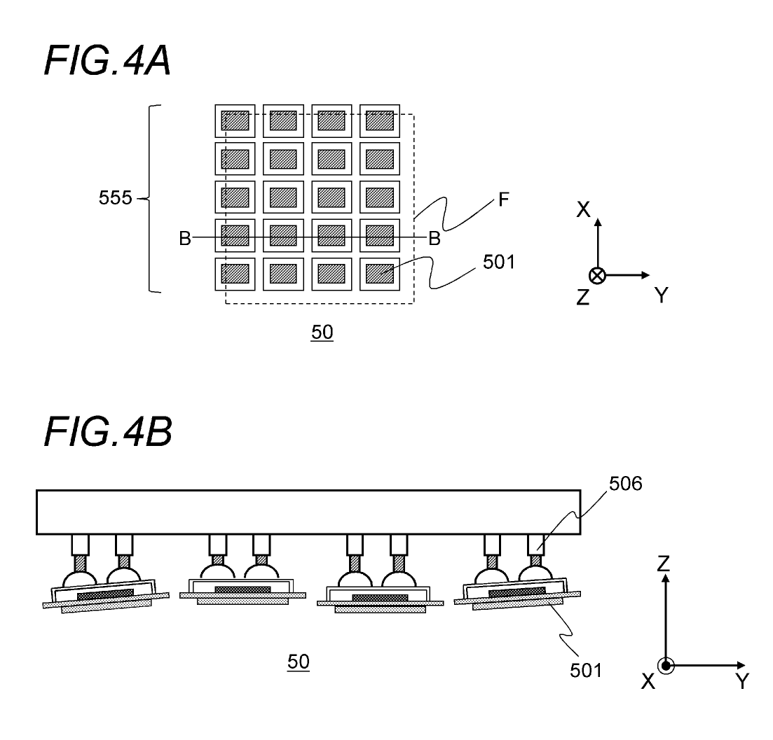

FIG. 4A is a top surface view of the imaging unit 50. As shown in FIG. 4A, the imaging unit 50 includes an image sensor group 555 constituted by a plurality of image sensors 501 which is two-dimensionally arranged (tiling arrangement) in a view field F of the imaging optical system 40. The imaging unit is configured to perform imaging of a plurality of images at once. A CCD sensor or a CMOS sensor can be used as the image sensor 501. The number of the image sensors 501 installed in the imaging unit 50 is determined as appropriate according to the surface area of the view field F of the imaging optical system 40. The arrangement of the image sensors 501 is also determined as appropriate according to the shape of the view field F of the imaging optical system 40 or the shape and configuration of the image sensors 501. In the present embodiment, to facilitate the understanding, a configuration is considered in which 5×4 CMOS sensors are arranged on the XY plane as the image sensor group 555.

In the typical imaging unit 50, an insensitive region (white portion in FIG. 4A), such as a substrate, is present around the light-receiving region (gray portion in FIG. 4A) of the image sensor 501. Therefore, it is impossible to arrange the image sensors 501 so that no gap is present therebetween. For this reason, in the image obtained in one image pickup cycle of the imaging unit 50, the portions corresponding to the gaps between the image sensors 501 are wiped out. Accordingly, in the imaging apparatus 100 of the present embodiment, an omission-free image of the specimen 302 is acquired by performing the imaging operation a plurality of times, while moving the test object stage 20 and changing the relative arrangement of the test object 30 and the image sensor group 555, in order to fill the gaps between the image sensors 501. By performing such an operation at a high speed, it is possible to perform the imaging of a wide region, while shortening the time required for imaging.

FIG. 4B is a view of the imaging unit 50 taken from the X direction. As shown in the figure, the imaging unit 50 has a drive mechanism 506 including a plurality of drive units. The position and posture of each image sensor 501 can thus be individually controlled. The position and posture control of each image sensor 501 is performed using surface profile information 91 obtained with the below-described surface profile measurement device 2.

The surface profile measurement device 2 is explained below. The surface profile measurement device 2 is a unit for measuring the surface profile (height distribution) of the test object 30. When there is waviness on the cover glass 301 of the test object 30, the focusing plane relating to the specimen 302 also becomes a wavy curved surface. In such a case, where the image of the specimen 302 is formed in a state in which the imaging planes of the image sensor group 555 are arranged on the same plane, some imaging planes will be set apart from the focusing plane (focusing position) and will not be accommodated within the focal depth of the imaging optical system 40. As a result, the image of the specimen 302 projected on these imaging planes is blurred, and the digital image in which the blurred portion is present is acquired by the imaging apparatus 100. Accordingly, in the imaging apparatus 100 of the present embodiment, the surface profile of the test object 30 is measured by the surface profile measurement device 2, and the control unit 4 calculates the drive amount of each drive mechanism 506 on the basis of the measured information. The control unit 4 calculates the drive amount and transmits a command value 52 to the drive mechanisms 506 such that those image sensors 501 of the image sensor group 555 for which the focusing plane and imaging plate are separated from each other are brought closer to the focusing plane.

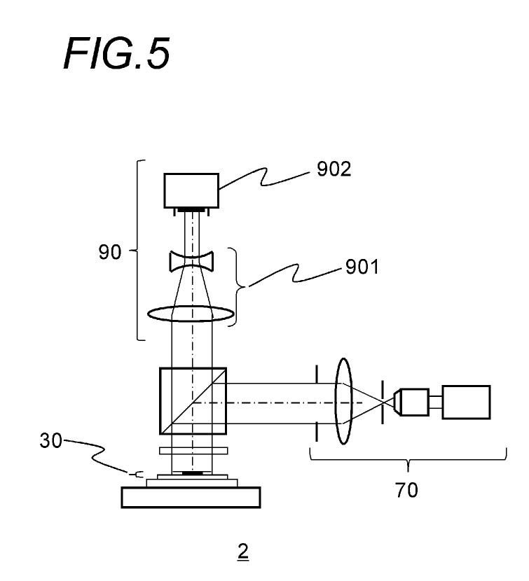

As shown in FIG. 1, the surface profile measurement device 2 includes an illumination unit 70 that illuminates the test object 30 and a measuring unit 90 that measurers the surface profile of the test object 30. As shown in FIG. 5, the measuring unit 90 has a variable-magnification optical system 901 and a wavefront sensor 902 that measures the wavefront of the incident light. The variable-magnification optical system 901 is configured such that of the test object 30 and the wavefront sensor 902 are optically conjugated and the imaging magnification can be changed. In the present embodiment, a Shack-Hartmann wavefront sensor is used as the wavefront sensor 902, but the wavefront of the reflected light may be also detected using an interferometer (for example, such as Shearing interferometer) instead of the Shack-Hartmann wavefront sensor.

The measurement region of the wavefront sensor 902 is preferably such that the shape (height distribution) of the entire surface of the cover glass 301 can be detected at once, but the size of the measurement device 2 increases with the expansion of the measurement region. Meanwhile, where the measurement region of the wavefront sensor 902 is narrow, the measurement device 2 can be reduced in size, but it is necessary to move the test object stage 20 and perform the measurements a plurality of times in order to measure the entire region of the cover glass 301 where the specimen 302 is present. In Embodiment 1, the field angle of the measurement region of the surface profile measurement device 2 is made equal to the field angle of the imaging region of the microscope 1 in order to perform the surface profile measurements of the test object with good efficiency, without unnecessarily increasing the measurement device 2 in size. It is not necessary that the field angles of the measurement region and imaging region be identical, and these angles can be independently set to any sizes.

The wide-range image pickup device 3 is described below. The wide-range image pickup device 3 is a unit for acquiring an image that is used to specify the region in which the specimen 302 (imaging object) is present, from the entire region of the test object 30, which is the subject. As shown in FIG. 1, the wide-range image pickup device 3 has a wide-range image pickup camera 80. The wide-range image pickup camera 80 may have a resolution lower than that of the imaging unit 50 of the microscope 1, but is required to have a field angle at least such that the image of the entire region of the cover glass of the test object 30 can be picked up. The wide-range image pickup camera 80 makes it possible to grasp the region of the test object 30 in which the specimen 302 is present prior to the measurements with the surface profile measurement device 2 or imaging with the microscope 1. The image of the entire region of the test object that has been picked up by the wide-range image pickup camera 80 is transmitted as wide-range image pickup information 81 to the control unit 4.

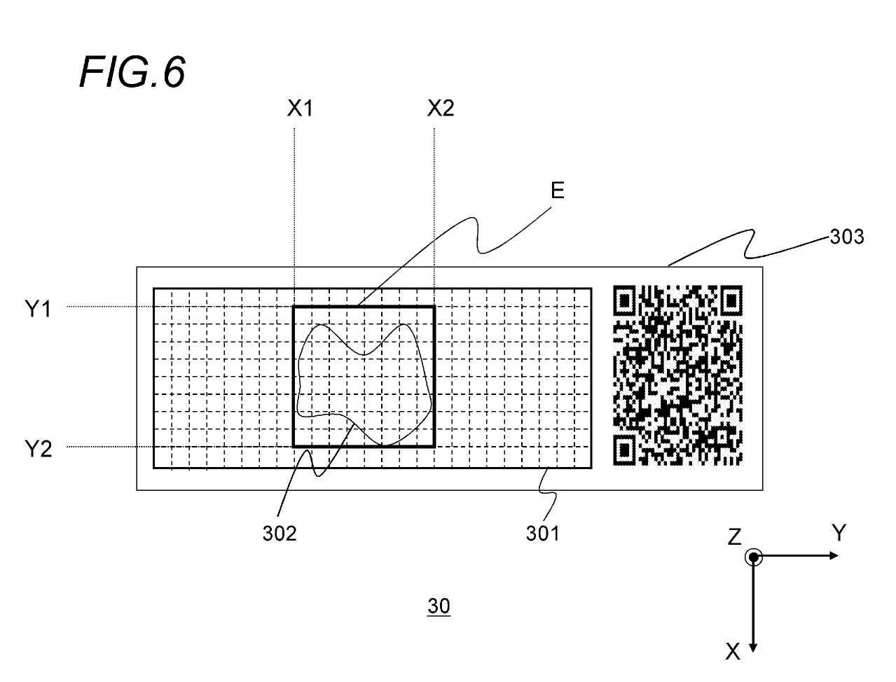

FIG. 6 illustrates the presence region E of the test object 30. When the present region E is defined by a rectangle, as shown in FIG. 6, the values of coordinate values X1, X2, Y1, Y2 can be determined by the control unit 4 and the presence region E of the specimen 302 can be determined on the basis of the wide-range image pickup information 81 of the wide-range image pickup camera 80. Each rectangular region demarcated by the broken lines in FIG. 6 represents one measurement region (or imaging region).

The control unit 4 sends a measurement command 92 to the surface profile measurement device 2 and sends a drive command 22 to the test object stage 20 such that only the presence region E of the test object 30 in which the specimen 302 is present is measured by the surface profile measurement device 2. Further, the control unit 4 sends an imaging command 52 to the imaging unit 50 and sends the drive command 22 to the test object stage 20 such that the microscope 1 performs imaging only with respect to the presence region E of the test object 30 in which the specimen 302 is present. As a result, the surface profile measurements or imaging relating to regions other than the presence region E of the specimen 302 can be omitted and the processing time can be shortened. In the example shown in FIG. 6, a total of 10×25=250 measurements are necessary to measure the entire surface profile of the cover glass 301. By contrast, where the measurements are performed only with respect to the presence region E, merely 8×8=64 measurements will suffice. Therefore, simple calculation demonstrates that the surface profile measurement time is shortened to about ¼.

Further, with the imaging apparatus 100, error detection of the test object 30 can be also performed using the wide-range image pickup information 81 of the wide-range image pickup camera 80. Examples of errors relating to the test object 30 include a state in which the cover glass 301 shifts and spreads beyond the slide glass 303 and also abnormal shape and coloration of the specimen. Error detection of this kind can be performed by using a well-known image analysis processing, for example, such as binarization, specific value extraction, and contour detection. The test object 30 for which an error has been detected is recovered by the carry-in/carry-out device 200 before such a test object is supplied to the surface profile measurement device 2.

It is also possible to enlarge the imaging region of the wide-range image pickup camera 80 and enable imaging including the region of the label 333, thereby making it possible to read the label 333 by using the wide-range image pickup information 81 of the wide-range image pickup camera 80.

The carry-in/carry-out device 200 places the test object 30 accommodated in the stocker 201 to the test object stage 20 with a transport unit (not shown in the figure). A hand device or the like can be considered as a specific mechanism of the transport unit. A label reader (not shown in the figure) for the test object 30 may be installed inside the carry-in/carry-out device 200 to read the label 333.

After the imaging with the microscope 1 has been completed, the control unit 4 transmits the image of the test object 30 obtained by microscope imaging on the basis of imaging information 51 from the imaging unit 50 to the image processing device, storage device, or display device (not shown in the figure). When the image data acquired by the microscope 1 are required to be processed, for example, by development, gamma conversion, color conversion, and synthesis, these types of processing may be performed in the image processing device or in a computational circuit (not shown in the figure) provided inside the imaging device 100.

### (Operation of the Imaging Apparatus)

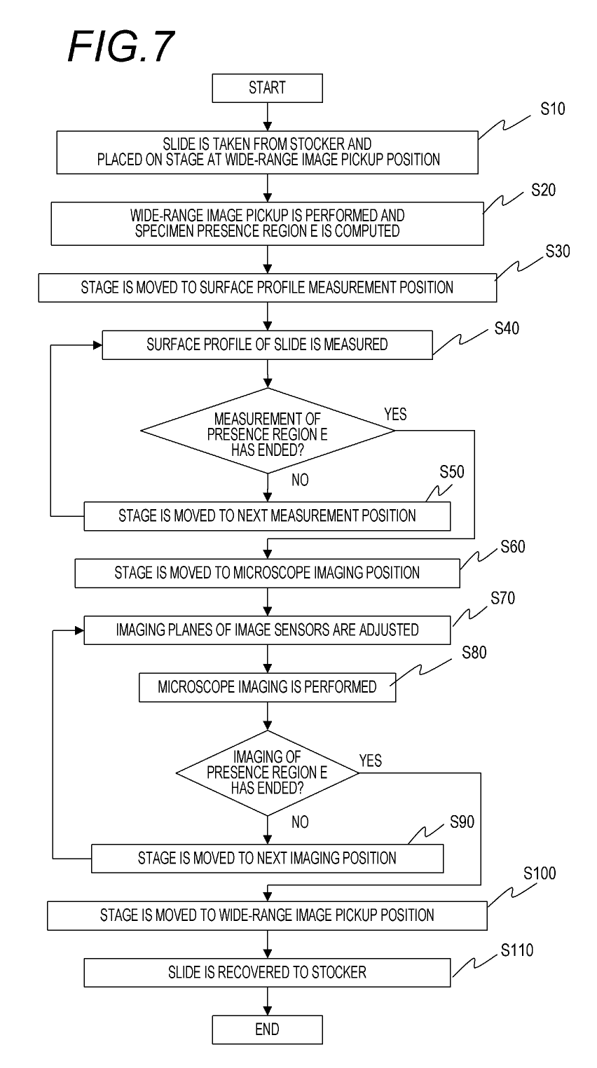

The operation of the imaging apparatus 100 of Embodiment 1 will be explained below with reference to the flowchart shown in FIG. 7.

First, the carry-in/carry-out device 200 takes out the test object 30 from the stocker 201 in response to a transport command from the control unit 4 and places the test object on the test object stage 20 located at a position of the wide-range image pickup device 3 (S10). The wide-range image pickup camera 80 performs wide-range image pickup (entire body image pickup) of the test object 30 in response to an image pickup command 82 from the control unit 4. The control unit 4 then detects a portion where the specimen 302 is present from the wide-range image pickup information 81 by image analysis and specifies the presence region E (S20). The portion with the specimen 302 in the test object (slide) 30 and the background portion outside thereof usually differ significantly in brightness and color. Therefore, the portion with the specimen 302 can be detected by using the conventional image analysis processing such as binarization, specific value extraction, and contour detection.

The test object stage 20 that holds the test object 30 then moves to the measurement position of the surface profile measurement device 2 in response to the transport command from the control unit 4 (S30). The surface profile measurement device 2 measures the surface profile of the test object 30 in response to the measurement command 92 from the control unit 4 (S40). In this case, the surface profile measurement device 2 measures only the presence region E of the specimen 302 that has been specified in S20. When the entire presence region E cannot be measured in one cycle of surface profile measurements, the test object stage 20 is moved to the next measurement position (S50) and the measurement of the surface profile is performed again (S40). The steps S40 and S50 are repeated till the measurement of the surface profile of the entire presence region E is completed.

Once the measurement of the surface profile of the presence region E is completed, the test object stage 20 moves to the imaging position of the microscope 1 in response to the transport command from the control unit 4 (S60). The control unit 4 calculates the focusing curve of the specimen 302 on the basis of the magnification ratio of the imaging optical system 40 and the surface profile information 91 on the test object 30 that has been acquired in S40. The control unit 4 sends the command value 52 to the drive mechanism 506 of each image sensor 501 and controls the posture of each image sensor 501 so that the imaging surface follows the calculated focusing curve (S70).

Imaging is then performed with the microscope 1 and a digital image is acquired (S80). When the imaging of the entire presence region E cannot be performed in one cycle of imaging, the test object stage 20 is moved to the next imaging position (S90). The imaging plane of the image sensors 501 is adjusted (S70) and the imaging is performed again (S80). The steps S70, S80, and S90 are repeated till the imaging of the entire present region E is completed. Once the imaging of the presence region E is completed, the test object stage 20 is moved to the position of the wide-range image pickup device 3 (S100) in response to the transport command from the control unit 4, and the test object 30 is recovered to the stocker 201 (S110).

As described hereinabove, with the configuration of Embodiment 1, the region E of the test object 30 where the specimen 302 is present can be grasped in advance, prior to the measurements with the surface profile measurement device 2 or imaging with the microscope 1, with the wide-range image pickup camera 80. As a result, measurements of the surface profile or imaging relating to the regions where the specimen 302 is not present can be omitted and therefore the processing time for surface profile measurements and imaging can be shortened. As a consequence, the processing capacity (throughput) of the entire imaging apparatus 100 can be increased.

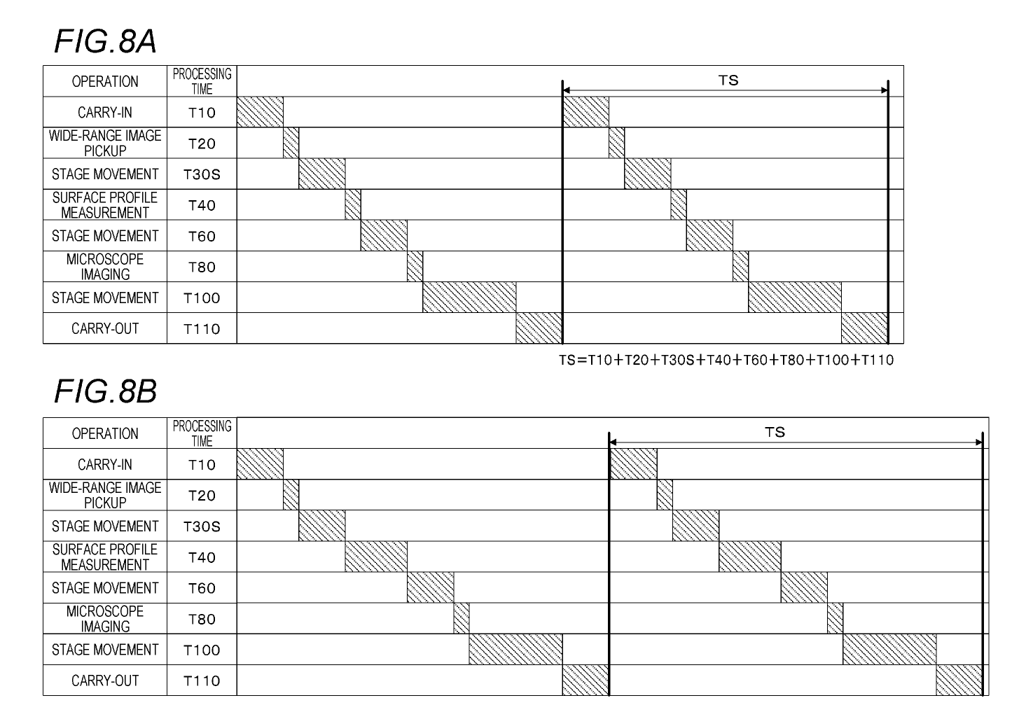

In FIG. 8A, the processing time of each operation of the imaging apparatus of Embodiment 1 is represented on a time axis. For comparison, FIG. 8B shows the processing time in the case where the surface profile of the entire cover glass is measured with the surface profile measurement device 2. In FIGS. 8A and 8B, the processing time necessary for each operation is represented as follows.

T10: carry-in time of the test object 30.

T20: wide-range image pickup time and computation time of the presence region E.

T30S: movement time from the wide-range image pickup position of the test object stage 20 to the surface profile measurement position.

T40: surface profile measurement time.

T60: movement time from the surface profile measurement position of the test object stage 20 to the microscope imaging position, or the movement time from the microscope imaging position of the test object stage 20 to the surface profile measurement position.

T80: microscope imaging time (including fine movement time of the test object stage 20 for filling the gaps between the image sensors 501).

T100: movement time from the microscope imaging position of the test object stage 20 to the wide-range image pickup position.

T110: carry-out time of the test object 30.

In Embodiment 1, the processing time TS required to acquire the image of one test object 30 is represented by the following formula:

TS=T10+T20+T30S+T40+T60+T80+T100+T110.

In Embodiment 1, the surface profile measurement time T40 is greatly shortened and the processing time TS is shortened by comparison with the conventional processing time (FIG. 8B) by restricting the surface profile measurement region to the specimen presence region E.

### Embodiment 2

In Embodiment 1, a constant holding state of the test object 30 can be maintained. Therefore, such an embodiment is suitable in the case where highly accurate holding reproducibility is required for the wide-range image pickup device 3, surface profile measurement device 2, and microscope 1. However, since the processing of the next test object cannot be started till after the entire processing of one test object is completed (that is, till after the test object is returned to the stocker), the total processing time increases when a large number of test bodies are processed continuously.

Accordingly, in Embodiment 2, a configuration is used in which the throughput of the imaging apparatus is further increased by performing in parallel some of the operations relating to image acquisition. In order to perform such parallel processing, it is possible to provide a member that holds the test object 30 separately from the test object stage 20 in the operations relating to image acquisition and transfer the test object 30 between the member and the test object stage 20. As a result, the processing preceding the transfer of the test object 30 can be performed in parallel with that following the transfer.

Where the test object 30 is transferred between the surface profile measurement device 2 and the microscope 1, the holding state (position or posture on the stage, stresses occurring in the test object 30, etc.) of the test object 30 changes between the surface profile measurement device 2 and the microscope 1. Accordingly, the surface profile (waviness) of the cover glass 301 varies between the state at the surface profile measurement position and the state at the imaging position of the microscope 1. Therefore, even if the position or posture of the image sensor group 555 of the microscope 1 has been adjusted according to the surface profile measured by the surface profile measurement device 2, the imaging plane cannot be brought close to the correct focusing plane. For this reason, it is undesirable that the test object 30 be transferred between the surface profile measurement device 2 and the microscope 1.

Accordingly, in the imaging apparatus of Embodiment 2, the transfer of the test object 30 is performed between the wide-range image pickup device 3 and the surface profile measurement device 2. This is because the presence region E of the test object 30 where the specimen 302 is present may be generally (with an accuracy of about 100 μm) grasped and therefore it is not necessary for the holding state of the test object 30 to be exactly the same between the wide-range image pickup device 3 and the surface profile measurement device 2. Meanwhile, between the surface profile measurement device 2 and the microscope 1, the holding state of the test object 30 should be the same (allowed error is about 0.1 μm) and therefore the test object stage 20 that holds the test object 30 performs a reciprocating movement without changing the holding state of the test object 30. It follows from above, that in Embodiment 2, by transferring the test object 30 between the wide-range image pickup device 3 and the surface profile measurement device 2, it is possible to perform in parallel the operations of S10, S20 and S110 shown in FIG. 7 and the operations of S40 to S90, and an imaging apparatus with increased processing speed is realized.

Accordingly, the Embodiment 2 is suitable for realizing an imaging apparatus with increased processing speed in the case where the holding states of the test object 30 in the wide-range image pickup device 3 and the surface profile measurement device 2 are not required to match perfectly.

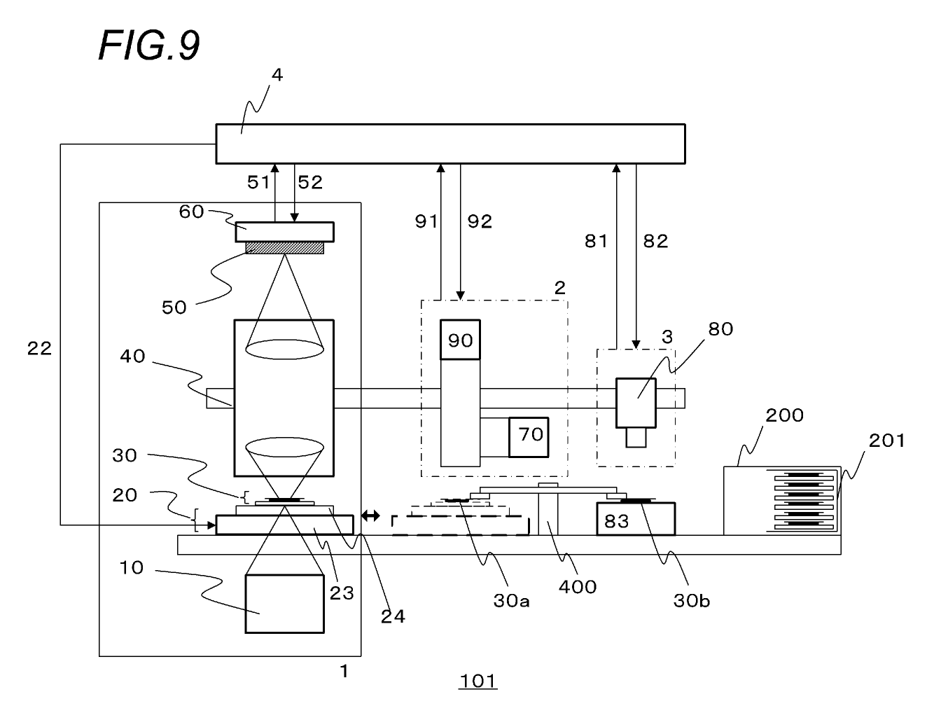

The configuration of an imaging apparatus 101 of Embodiment 2 is shown in FIG. 9. The difference between this embodiment and Embodiment 1 is that the test object 30 carried in from the carry-in/carry-out device 200 is placed on a wide-range image pickup stand 83 of the wide-range image pickup device 3 and thereafter transferred from the wide-range image pickup stand 83 to the test object stage 20 by an exchange hand 400. The test object stage 20 performs a reciprocating movement between the surface profile measurement device 2 and the microscope 1, without changing the holding of the test object 30 carried thereon.

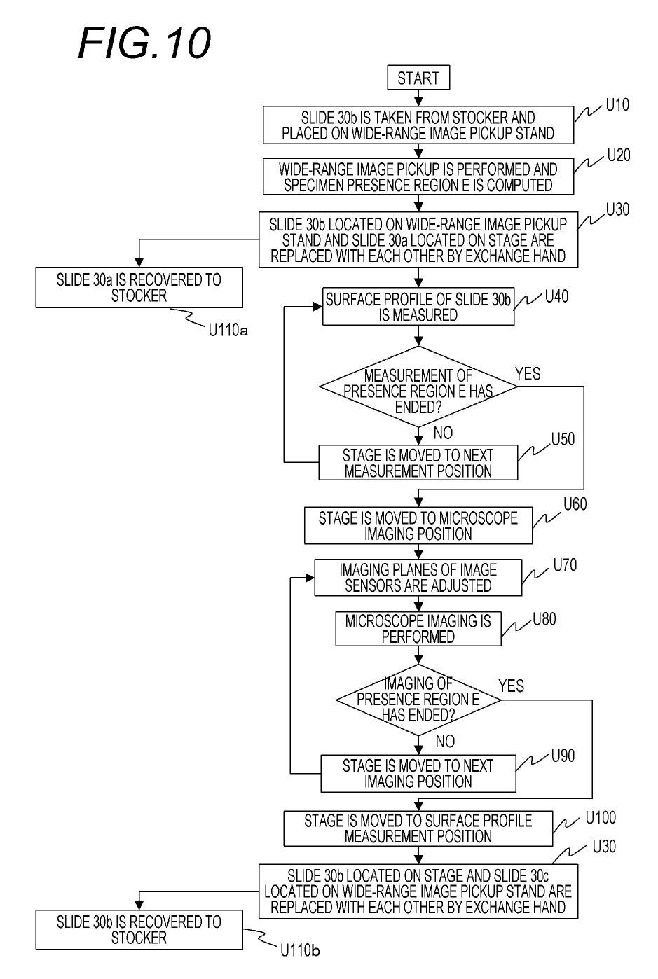

The operation of the imaging apparatus 101 of Embodiment 2 is described below with reference to the flowchart shown in FIG. 10.

First, a carry-in/carry-out device 200 takes a test object 30b out of a stocker 201 and places the test object on the wide-range image pickup stand 83 in response to the transport command from the control unit 4 (U10). Similarly to Embodiment 1, the wide-range image pickup camera 80 picks up the image of the test object 30b, and the control unit 4 calculates the presence region E of the specimen 302 from the wide-range image pickup information 81 (U20).

The exchange hand 400 moves the test object 30b for which the wide-range image pickup has ended onto the test object stage 20 and, at the same time, moves the test object 30a for which the imaging in the microscope 1 has been completed and which is at the position of the surface profile measurement device 2 onto the wide-range image pickup stand 83 (U30). In other words, the exchange hand 400 replaces the test object on the wide-range image pickup stand 83 and the test object on the test object stage 20 with each other.

Then, the test object 30a is recovered to the stocker 201 by the carry-in/carry-out device 200 (U110a), and the surface profile of the test object 30b is measured by the surface profile measurement device 2 (U40). In this case, similarly to Embodiment 1, the surface profile measurement is also performed only with respect to the presence region E of the specimen determined in U20, and the measurements with respect to regions other than the presence region E are omitted (U40, U50).

Once the surface profile measurement of the presence region E has been completed, the test object stage 20 moves to the position of the microscope 1 in response to the transport command from the control unit 4 (U60). Then, similarly to Embodiment 1, the posture of each image sensor 501 is controlled according to the surface profile of the test object 30b, imaging is performed with the microscope 1, and a digital image is acquired (U70, U80, U90).

Once the imaging of the presence region E has been completed, the test object stage 20 moves to the position of the surface profile measurement device 2 in response to the transport command from the control unit 4 (U100). As described hereinabove, the test object 30b for which the microscope imaging has been completed is replaced by the exchange hand 400 with the newly carried-in test object and placed on the wide-range image pickup stand 83 (U30). Finally, the test object 30b is recovered to the stocker 201 by the carry-in/carry-out device 200 (U110b).

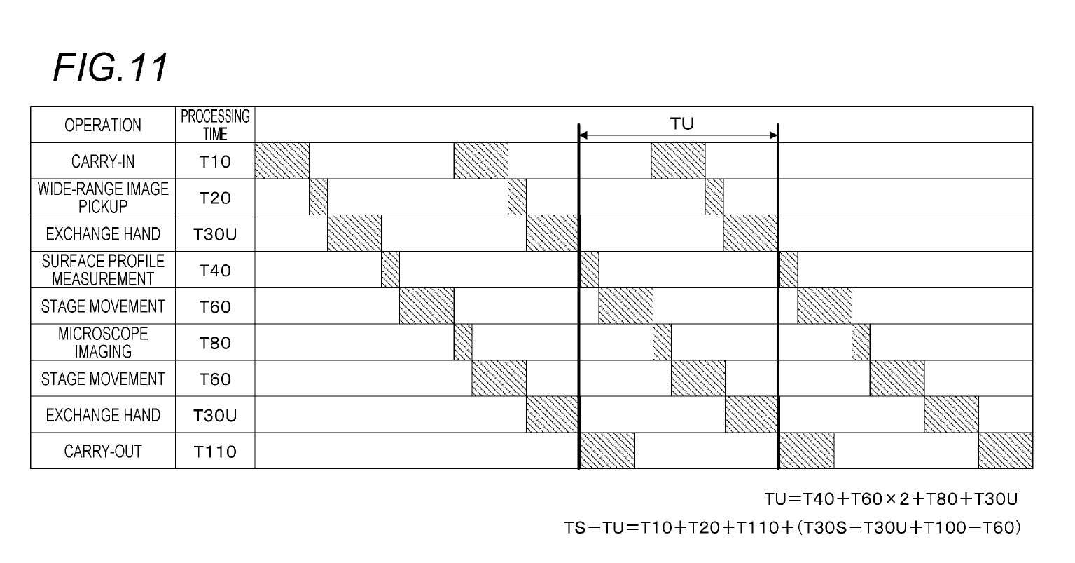

In FIG. 11, the processing time of each operation of the imaging apparatus of Embodiment 2 is represented on a time axis. In this case, the processing time necessary for each operation is represented as follows.

T10: carry-in time of the test object 30.

T20: wide-range image pickup time and computation time of the presence region E.

T3OU: time required for the exchange hand 400 to move the test object from the wide-range image pickup position to the surface profile measurement position.

T40: surface profile measurement time.

T60: movement time from the surface profile measurement position of the test object stage 20 to the microscope imaging position, or the movement time from the microscope imaging position of the test object stage 20 to the surface profile measurement position.

T80: microscope imaging time (including fine movement time of the test object stage 20 for filling the gaps between the image sensors 501).

T110: carry-out time of the test object 30.

As shown in FIG. 11, in Embodiment 2, the carry-in process of the test object can be started and a processing such as wide-range image pickup can be performed before the test object for which the imaging has been earlier performed is carried out. Accordingly, where the carry-in process of the test object 30 is started and a processing such as wide-range image pickup or presence region specification is performed while the measurement or imaging is being performed with respect to the test object 30 located on the test object stage 20, the processing time can be shortened. The loss of time is the smallest when the timing at which the test object that has been earlier subjected to imaging is returned by stage movement to the surface profile measurement device (U100) matches the timing at which the wide-range image pickup of the next test object is completed (U20). The control unit 4 may start the carry-in operation of the next test object so as to obtain such a timing. The carry-in time T10, wide-range image pickup time T20, time T3OU for the movement performed by the exchange hand, and stage movement time T60 can be determined in advance, and the surface profile measurement time T40 and microscope imaging time T80 can be calculated on the basis of the size of the presence region E (number of measurement/imaging cycles).

When the loss of time is thus minimized, the processing time TU required for image acquisition of one test object 30 can be represented by the following equation.

TU=T40+T60×2+T80+T3OU

In Embodiment 2, the processing time per one test object is shortened by TS−TU by comparison with that of Embodiment 1.

TS−TU=T10+T20+T110+(T3OS−T3OU+T100−T60)

Where T3OS−T3OU+T100−T60≧0, it is clear that in Embodiment 2 the processing time can be shortened at least by T10+T20+T110, that is, by the carry-in time, wide-range image pickup time and computation time of the presence region E, and carry-out time, by comparison with that of Embodiment 1.

The preferred embodiments of the present invention are described above, but it goes without saying that the present invention is not limited to those embodiments and can be variously changed or modified without departing from the scope thereof.

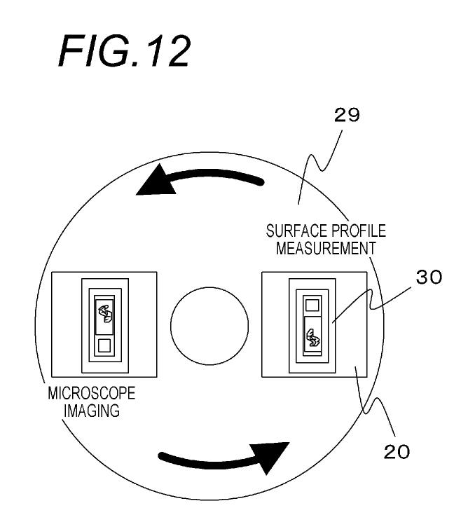

For example, in Embodiment 2, the test object 30 is transported between the surface profile measurement device 2 and the microscope 1 by reciprocatingly moving a direct-operated stage such as shown in FIG. 9, but the test object 30 may be also transported by using a rotary table 29 such as shown in FIG. 12. Further, when the alignment accuracy of the test object 30 can be confirmed, the test object 30 may be transferred between the surface profile measurement device 2 and the microscope 1.

In the above-described embodiments, the presence range of the specimen is specified by using an image picked up by the camera, but a configuration in which the presence range of the specimen is detected by using a sensor other than the camera may be also advantageously used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-131594, filed on Jun. 13, 2011, which is hereby incorporated by reference herein in its entirety.

What is claimed is:

1. An imaging apparatus comprising:
a holding unit that holds a subject;
a surface profile measuring unit that measures a surface profile of the subject; and
an imaging unit that adjusts an imaging plane according to the surface profile measured by the surface profile measuring unit and performs imaging of the subject, wherein
the imaging apparatus has a specifying unit that specifies a presence region in which an imaging object is present from an entire region of the subject; and
the surface profile measuring unit measures only the surface profile of the presence region specified by the specifying unit.

2. The imaging apparatus according to claim 1, wherein the imaging unit images only the presence region specified by the specifying unit.

3. The imaging apparatus according to claim 1, wherein
the specifying unit has a wide-range image pickup unit that picks up an image of the entire region of the subject and a detecting unit that detects the imaging object by analyzing the image of the entire region of the subject that has been picked up by the wide-range image pickup unit.

4. The imaging apparatus according to claim 3, wherein the holding unit has a stage that moves between a measurement position of the surface profile measuring unit and an imaging position of the imaging unit, while holding the subject.

5. The imaging apparatus according to claim 3, wherein the holding unit has a stage that moves between an image pickup position of the wide-range image pickup unit, a measurement position of the surface profile measuring unit and an imaging position of the imaging unit, while holding the subject.

6. The imaging apparatus according to claim 3, wherein the holding unit has a stage that moves between a measurement position of the surface profile measuring unit and an imaging position of the imaging unit, while holding the subject, and an exchange unit that replaces a subject held at the stage and a subject that is at the image pickup position of the wide-range image pickup unit with each other.

7. The imaging apparatus according to claim 6, wherein the specifying unit performs processing of specifying a presence region with respect to a subject in the image pickup position of the wide-range image pickup unit, while measurement processing by the surface profile measuring unit and imaging processing by the imaging unit are performed with respect to a subject held at the stage.

8. The imaging apparatus according to claim 6, further comprising:
a stocker that stores a plurality of subjects; and
a transport unit that transports subjects from the stocker, wherein
the transport unit transports a next subject from the stocker to the image pickup position of the wide-range image pickup unit, while measurement processing by the surface profile measuring unit and imaging processing by the imaging unit are performed with respect to a subject held at the stage.

9. The imaging apparatus according to claim 3, further comprising:
an error detecting unit that performs error detection of the subject by analyzing the image of the entire region of the subject that has been picked up by the wide-range image pickup unit.

10. A control method for an imaging apparatus provided with a holding unit that holds a subject; a surface profile measuring unit that measures a surface profile of the subject; and an imaging unit that adjusts an imaging plane according to the surface profile measured by the surface profile measuring unit and performs imaging of the subject,
the control method comprising:
a specifying step of specifying a presence region in which an imaging object is present from an entire region of the subject; and
a measuring step of measuring by the surface profile measuring unit only a surface profile of the presence region specified in the specifying step.
